(19) United States
(12) Patent Application Publication
(10) Pub. No.: US 2014/0372304 A1
(43) Pub. Date: Dec. 18, 2014

(54) GEO-ENUMERATIVE DEVICEHOLDER AUTHENTICATION

(71) Applicant: MasterCard International Incorporated, Purchase, NY (US)

(72) Inventor: Justin Xavier Howe, Oakdale, NY (US)

(21) Appl. No.: 13/920,920

(22) Filed: Jun. 18, 2013

(51) Int. Cl. G06Q 20/40

(52) U.S. Cl. CPC G06Q 20/4014
USPC 705/44

(57) ABSTRACT

A system, method, and software product are provided for fraud prevention in the field of payment instrument transactions without requiring registration. A computing device receives details of completed payment transactions. A number of recognition IDs are also received indicating locations of geolocation devices. A computing device then flags all received recognition IDs by deviceholder identification for a time period surrounding the completed payment transactions, and defines sets of flagged recognition IDs. The sets of flagged recognition IDs are then compared in generating candidate recognition IDs, which are associated with each payment instrument. Further iterations allow for limiting of the number of recognition IDs associated with each payment instrument. Other embodiments provide for faster matching by only considering recognition IDs from a certain geographic region or presenting time-limited offers to customers to purchase goods at specific merchants and then removing recognition IDs not associated with purchase at a merchant.

### FIELD OF THE DISCLOSURE

The present disclosure relates to fraud prevention or data mining in the field of payment instrument transactions. More specifically, disclosed is a system, method, and computer product for association of a geolocation device configured to transmit a recognition ID with a payment instrument being used to make purchases. Such system, method, and computer product provides benefits of fraud prevention and data mining in payment instrument transactions without demanding explicit registration of payment instrument holders in a program to track the location where purchases are made.

### BACKGROUND OF THE DISCLOSURE

Payment card companies (presently better referred to presently as “payment instrument” institutions, thanks to a variety of new technologies for making payments including not only credit cards and debit cards, but also electronic wallets, transponder devices, near-field communication-enabled (“NFC”) smartphones, or similar presently existing or after-arising technology) are confronted with the daily task of determining which of the millions of transactions being processed between consumers and merchants are real and which are fraudulent. It is estimated that the sum of all worldwide credit card fraud is $5.55 billion annually. “Credit Card Statistics,” available at http://www.statisticbrain.com/credit-card-fraud-statistics/ (last visited Apr. 26, 2013).

Numerous techniques are utilized by payment instrument issuing institutions to detect fraudulent transactions. Payment instrument institutions watch, for example, a small purchase followed immediately by a larger one, a purchase out of character with the usual buying habits of the individual, substantial online purchases, as well as a variety of other techniques. Many of the existing techniques have flaws inherent in them, and payment instrument issuing institutions constantly search for new and improved ways to avoid fraud. The existing techniques for registration-based fraud detection suffer from payment instrument holders that are wary, negligent in registering, or intentionally avoid registration in fraud prevention programs, avoiding the benefits they provide.

Accordingly, there is a need for a method, system, and computer product which offers an alternative way of preventing fraudulent payment instrument transactions and data mining without requiring explicit registration.

### SUMMARY OF THE DISCLOSURE

The present disclosure provides a method, system, and computer product for geo-enumerative deviceholder authentication by association of a personal computing device's recognition ID (such as by way of a non-limiting example, a phone number, a device ID, a social media handle, an IP address, or any unique identification generated by after-arising equivalent technology) allowing passive observation of the geolocation of an individual via a personal computing device and obtained through social media, SMS, the internet, telephone networks, a geolocation ping, access to a publicly-available wireless access point, or other equivalent or after-arising means, with a payment instrument associated with a deviceholder identification (identifying an account number, name, address, etc. of the payment instrument) of a recent transaction, of millions pending simultaneously through a payment instrument issuing institution and a payment instrument network. The present disclosure in its various embodiments operates via passive observation of a geolocation of a personal computing device (also known herein as a “geolocation device”) and not via active registration. Personal computing devices might be carried in a customer's or potential customer's purse as they shop, or in a car while they drive, for example. In another embodiment of the disclosure, however, active observation of the geolocation of a personal computing device is authorized by, for example, continuously monitoring GPS location transmitted from a mobile computing device. In either event, the present disclosure provides advantages in fraud prevention, as well as in data collection for customers, merchants, and the payment instrument issuing institutions alike.

In accordance with a first aspect of the present disclosure, during an execution of the presently disclosed method, system, and computer product, details of a first completed payment transaction associated with a payment instrument are received at a computing device associated with a matching database. A plurality of recognition IDs are also received at the computing device associated with the matching database indicating geolocations of a plurality of mobile computing devices. The holders of these mobile computing devices could be shopping, browsing merchandise, or just in the geographic area under scrutiny. In this embodiment, all recognition IDs received a time interval or time intervals relative to before and/or after completion of the first payment transaction are flagged to define a first set of flagged recognition IDs. Details of a second completed payment transaction associated with the same payment instrument are also received at the computing device. More recognition IDs are received, which are again fagged based upon receipt within a time interval or time intervals before and/or after completion of the second completed payment transactions in defining a second set of flagged recognition IDs. The first set of flagged recognition IDs and the further second set of flagged recognition IDs are then compared against each other to look for recognition IDs common to all sets of determined recognition IDs as candidate recognition IDs. The payment instrument is then associated with the candidate recognition IDs. Such resulting candidate recognition IDs are arranged either one payment instrument to one recognition ID, or one payment instrument to more than one recognition ID. Later executions of the presently disclosed method, system, and computer product allow for further limiting of the association between the payment instrument and more than one recognition ID, via further iterations of all or part of the present disclosure. As executions proceed, further recognition IDs are removed from the candidate set of recognition IDs and in some embodiments eventually only a single payment instrument is associated with a single recognition ID. This is a simple yet effective means to associate a single deviceholder identification with a single recognition ID after several iterations.

In accordance with a second aspect of the present disclosure, the presently disclosed method, system, and computer product serves to receive a geolocation of a completed payment included in the details received of a first completed payment transaction, Before, during, or after the computing device receives details of the completed payment transaction the computing device receives a plurality of recognition IDs. The recognition IDs are received within a time interval or intervals before and/or after completion of the first payment transaction are flagged when defining a first set of flagged recognition IDs. In this embodiment of the disclosure the computing device performs the further step after of removing from the first set of flagged recognition IDs all recognition IDs not within a distance of the geolocation identified by the details of the first completed payment transaction. As previously described, in this embodiment further iterations of this process can occur involving receipt of further completed transactions associated with the payment instrument, receipt of further recognition IDs, flagging of common recognition IDs as between iterations, etc. to remove recognition IDs not within distance of the geolocation of further completed payment transactions. The end result is a reduced number of iterations necessary to associate a recognition ID with a single deviceholder identification, via use of geolocation-based limiting.

In accordance with a third aspect of the present disclosure, the presently disclosed method, system, and computer product serves to further limit the amount of recognition IDs considered in matching a payment instrument with one or a small number of recognition IDs. In this embodiment a computing system associated with a matching database presents a time-limited offer to one or more potential customers for discounts on purchases of goods or services from specific merchants to a personal computing device associated with a potential customer. The time-limited offer can be made to all personal computing devices in a certain area or by any other criteria. If a purchase is made, details of a first completed payment transaction are received by the computing system associated with the matching database. As with previous embodiments, a plurality of recognition IDs associated with a plurality of geolocation devices are transmitted to the computing system. In this embodiment, however, rather than flagging all recognition IDs received within a time interval before the first completed payment transaction, only recognition IDs received within the time frame during which the time-limited offer is valid are flagged (since only these can be associated with the time-limited purchase), and then only if the recognition ID received indicates a geolocation consistent with a certain location where the specific merchant is located in defining a set of flagged recognition IDs. In other regards, this embodiment operates in the manner of other embodiments, and multiple iterations can be utilized if they are required to limit the number of recognition IDs associated with a payment instrument. This embodiment serves to dramatically lower the numbers of recognition IDs that are possible matches for the payment instrument, and further reduces the number of iterations necessary to match the two.

Various aspects of these embodiments can be interwoven to provide for more efficient association of a payment instrument with a single or multiple recognition IDs. In addition to the above aspects of the present disclosure, additional aspects, objects, features, and advantages will be apparent from the embodiments presented in the following description and in connection with the accompanying drawings.

### BRIEF DESCRIPTION OF THE DRAWINGS

Some embodiments are illustrated by way of example and not limitation in the figures of the accompanying drawings, in which like reference numerals refer to like structures across the several views, and wherein:

FIG. 1 illustrates a block diagram displaying the process of completing a payment instrument transaction in an embodiment of the disclosure.

FIG. 2 illustrates a flow chart displaying basic steps of a method comprising an embodiment of the disclosure.

FIG. 3 illustrates the basic steps of association a recognition ID with a payment instrument.

FIG. 4 illustrates a flow chart displaying basic steps of a method comprising an embodiment of the disclosure.

FIG. 5 illustrates a flow chart displaying basic steps of a method comprising an embodiment of the disclosure.

FIG. 6 displays an embodiment of the disclosure executing on a personal computing device.

### DETAILED DESCRIPTION OF THE EMBODIMENTS

The following sections describe exemplary embodiments of the present disclosure. It should be apparent to those skilled in the art that the described embodiments of the present disclosure are illustrative only and not limiting, having been presented by way of example only. All features disclosed in this description may be replaced by alternative features serving the same or similar purpose, unless expressly stated otherwise. Therefore, numerous other embodiments of the modification thereof are contemplated as falling within the scope of the present disclosure as defined herein and equivalents thereto.

Throughout the description, where items are described as having, including, or comprising one or more specific components, or where methods are described as having, including, or comprising one or more specific steps, it is contemplated that, additionally, there are items of the present disclosure that consist essentially of, or consist of, the one or more recited components, and that there are methods according to the present disclosure that consist essentially of, or consist of, the one or more recited processing steps.

As will be appreciated by one skilled in the art, the present disclosure may be embodied as a system, method, or computer program product. Accordingly, the present disclosure may take the form of an entirely hardware embodiment, an entirely software embodiment (including firmware, resident software, micro-code, etc.) or an embodiment combining software and hardware aspects that may generally be referred to herein as a “server,” “device,” “computing device,” “computer device,” or “system.” As is commonly known in the art, such devices are associated with a single or multiple processors or CPUs, which are specially programmed in order to perform a task at hand. Multiple computer systems can also be networked together in a local-area network or via the Internet to perform the same function. Furthermore, the present disclosure may take the form of a computer program product embodied in any tangible medium of expression having computer usable program code embodied in the medium. Computer program code for carrying out operations of the present disclosure may operate on any or all of a “server,” “computing device,” “computer device,” or “system” discussed herein. Computer program code for carrying out operations of the present disclosure may be written in any combination of one or more programming languages, including an object oriented programming language such as Java, Smalltalk, C++, or the like and conventional procedural programming languages, such as Visual Basic, “C,” or similar programming languages. After-arising programming languages are contemplated as well.

The present disclosure is described below with reference to flowchart illustrations and/or block diagrams of methods, apparatuses (systems), and computer program products according to embodiments of the disclosure. It will be understood that each block of the flowchart illustrations and/or block diagrams, and combinations of blocks in the flowchart illustrations and/or block diagrams, can be implemented by computer program instructions.

These computer program instructions may be provided to a processor of any “computing system,” or “computing device,” including a server, general purpose computer, special purpose computer, tablet pc, or any other programmable data processing apparatus to produce a machine, such that the instructions, which execute via the processor of the computer or other programmable data processing apparatus, create means for implementing the functions/acts specified in the flowchart and/or block diagram block or blocks. These computer programmable instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer device or other programmable apparatus to produce a computer-implemented process such that the instructions which execute on the computer device or other programmable apparatus provides processes for implementing the functions/acts specified in the flowchart and/or block diagram block or blocks.

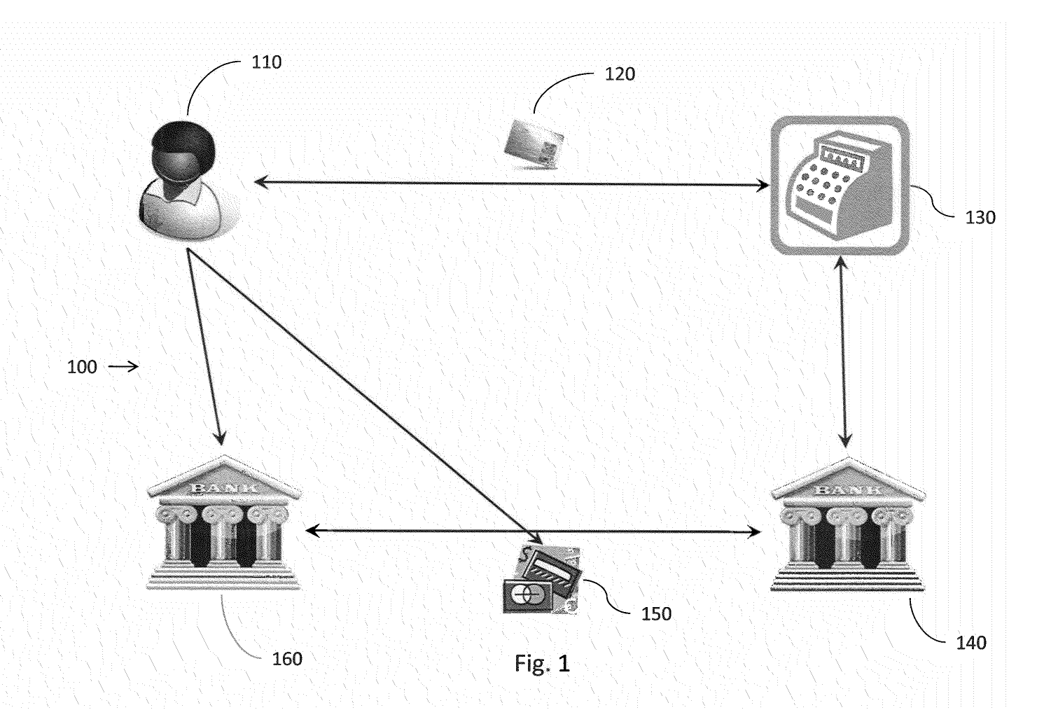

Referring to FIG. 1, there is shown a block diagram 100 displaying the general process of completing a payment transaction with a payment instrument in an embodiment of the disclosure. A customer (also known as a payment instrument holder) 110 desires to purchase a good or service from a merchant 130. The customer is carrying a personal computing device (also known herein as a “geolocation device”) as he or she shops (not shown here). Personal computing devices include cellular telephones, pagers, lap-tops, personal digital assistants, or other similar devices. Customer 110 presents a payment instrument 120 (such as a credit card, debit card, ATM card, CHIP card, electronic wallet, transponder device, NFC-enabled smart phone, PIN transaction, or similar current or after-arising technology) to the merchant 130 for payment in connection with a payment transaction. The merchant 130 utilizes his or her transaction acquiring device (also not shown) to communicate with a merchant acquiring institution or “Acquirer” 140 seeking approval for this transaction. The Acquirer 140 transmits an authorization message formatted pursuant to ISO 8583 (which is incorporated here in its entirety) or its present or after-arising equivalent. The authorization message contains “details” such as, at least, the customer's 110 payment instrument holder account identification, other account information, amount of the transaction, time of the transaction, etc. seeking approval of the transaction. The transmission is made via a payment instrument network 150 to a payment instrument issuing institution 160 associated with the payment instrument 120. Other “details” of a completed payment transaction are transmitted as well, including the preceding as well as (but not limited to) the geolocation of where a payment transaction is occurring, the time the transaction is occurring, and other related data. Should approval be appropriate, the payment instrument issuing institution 160 transmits an approval message via the payment instrument network 150 to the Acquirer 140 who then retransmits the approval message to the merchant 130, who thusly learns the sale has been completed. As previously discussed, the approval message is transmitted in formatting consistent with ISO 8583 or its present or after-arising equivalent.

In connection with the present disclosure, the customer 110 (or potential customer) broadcasts his or her geolocation using his or her personal computing device before, during, or after a payment transaction to the payment instrument issuing institution 160 and/or the payment instrument network 150 via a number of means as detailed below. Other customers, or potential customers (not shown here) also carrying personal computing device broadcast their own geolocation at the same time. The broadcast of geolocation can take place in active or passive fashion. In one embodiment, the broadcasting of geolocation of personal computing devices is a passive process, not requiring an active choice to enroll in a program designed to track geolocations. The payment instrument issuing institution 160 and payment instrument network 150 are able to recognize the geolocation of a personal computing device via a “recognition ID,” which could include a phone number utilized by the personal computing device within a telephone network or over the internet, a Bluetooth identification, a Wi-Fi login, a device ID, a social media handle, an IP address, or any other means of passively determining geolocation of a personal computing device without express consent of the holder of the personal computing device. These recognition IDs are obtained through observation of social media, SMS messages, a geolocation ping, logging into a public hot-spot, or other currently existing or after-arising technology. As a means of non-limiting example, the customer 110 transmits geolocation passively (without opt-in) via Bluetooth, Wi-Fi, IP Address, phone cookie, cell tower ping, or activation of a link on a cell phone application. Alternately, in an embodiment of the disclosure one or more customers 110 opts-in to transmit geolocation via GPS on a mobile computing device via, for example, checking-in, to offer redemption, sending an SMS requesting consent, answering a telephone call requesting consent, registration with a local node, etc., in order to allow more effective means of tracking of geolocation. In such an event, if consent is provided, a GPS location of the personal computing device can be provided dynamically or other data. These types of geolocation data can be updated continuously, at five minute intervals, at ten minute intervals, at hourly intervals, or according to any other period.

During operation of the present disclosure, a computing system associated with a matching database operated by the payment instrument issuing institution 160 or the payment instrument network 150 receives a number of recognition IDs (from one to billions) with each execution of the disclosure indicating locations associated with recognition IDs of personal computing devices associated with one customer 110 or many potential customers. The purpose of the present disclosure is to associate the passively (or actively) collected geolocation data regarding locations of personal computing devices with information on completed payment transactions associated with payment instruments to allow association of these two data-types essentially linking locations, merchant names, and payment instruments used to make purchases and provides various data collection benefits to payment instrument holders, merchants, and the payment instrument institutions alike.

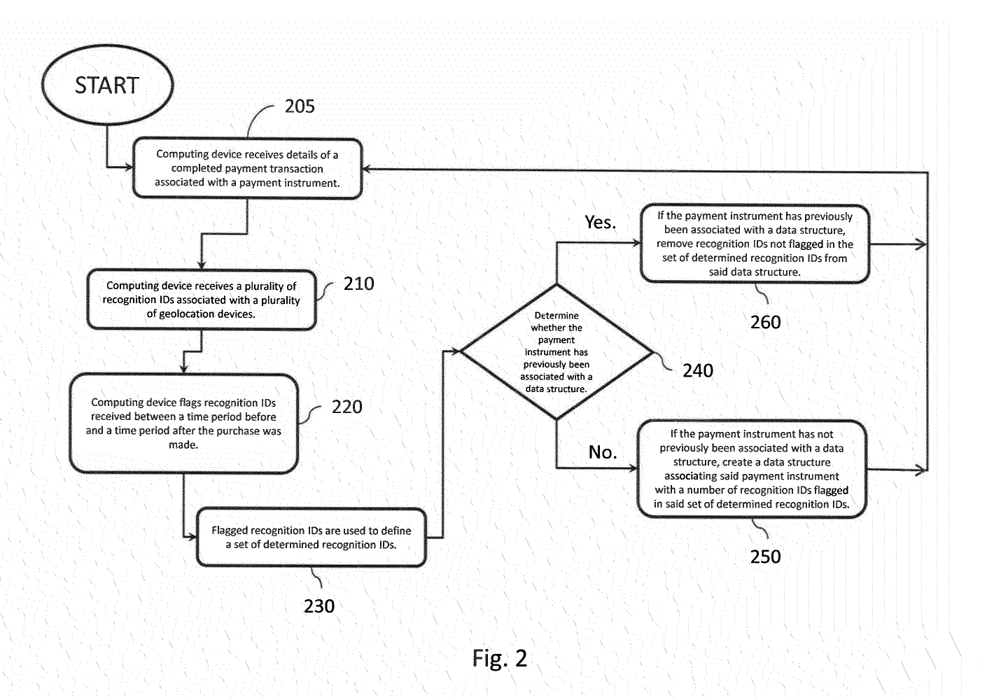

Referring to FIG. 2, shown is a flow chart displaying basic steps of a method comprising an embodiment of the disclosure. A computing device associated with a matching database receives details of a completed payment transaction associated with a payment instrument (step 205). Details of a completed payment transaction include any of, but are not limited to, the type of card used to make a purchase at a merchant, the name of the merchant, the amount of the purchase, the type of the purchase, the geolocation of the merchant, and the time the payment was completed. The computing device also receives a plurality of recognition IDs from personal computing devices associated with customers, potential customers, and other individuals possessing personal computing devices configured to transmit recognition IDs of merchants (step 210). These received recognition IDs can number from one to millions or billions. The recognition IDs each indicates the geolocation of a personal computing device. As stated previously, detection can occur in a passive manner, such as if customers or potential customers log-into a Wi-Fi network maintained by Starbucks® at a certain geolocation, make a call from a cellular telephone using a certain cell phone tower, log-into the internet after obtaining a certain IP address, etc. Alternately, the geolocation is tracked in an active manner pursuant to consent by a customer, as also discussed herein. The computing device associated with the matching database then flags all recognition IDs if they are received between a time period or time periods (also known as “time interval[s]”) after a completion of the payment instrument transaction (step 220) and utilize flagged recognition IDs to define a set of flagged recognition IDs (step 230). In some embodiments, the time period before the transaction was processed and the time period after the transaction was processed are symmetric (i.e., they are equal), e.g. ten minutes before and after the transaction. In other embodiments of the disclosure, asymmetric time periods may be used where the before and after time periods are different, such as the time period before the transaction was processed is ten minutes and the time period after the transaction was processed is forty-five minutes. In some embodiments the time periods range between five minutes and one hour. Finally, in some embodiments only one time period before or after completion of the completed payment transaction is considered.

The flagged recognition IDs flagged in these time periods are then placed into a computer storage unit, such as any type of linked list, nodes, structure, text file, object, variable, SQL-database, or other type of data storage unit capable of storing such data, as would be understood by one of skill in the art. In some embodiments, the computing device then determines whether the payment instrument has been previously associated with a data structure (step 240). If the payment instrument has not been previously associated with a data structure linking the payment instrument with candidate recognition IDs, execution proceeds in step 250 to creating a data structure associating the payment instrument (and associated with deviceholder identification) with a number of recognition IDs previously flagged in the set of flagged recognition IDs. The data structure takes the form of any data structure, including objects, variables, text files, SQL-databases, or any other data storage unit capable of storing such data. This newly-created data structure will associate all flagged recognition IDs with a payment instrument (as further discussed below). While this might provide none-to-one matching of a recognition ID and a payment instrument at an early stage, further iterations of the disclosure described herein can provide more specific information. On the other hand, if a payment instrument has previously been associated with a data structure, at step 260 the recognition IDs not found presently in the set of determined recognition IDs can simply be removed or dissociated, leaving less possible matches of payment instruments to recognition IDs. In either event, after step 250 or 260, execution returns to step 205, allowing for further successive iterations further limiting the number of recognition IDs associated with a payment instrument. In other embodiments, instead of a data structure, a modification is performed to a set of determined recognition IDs as execution proceeds.

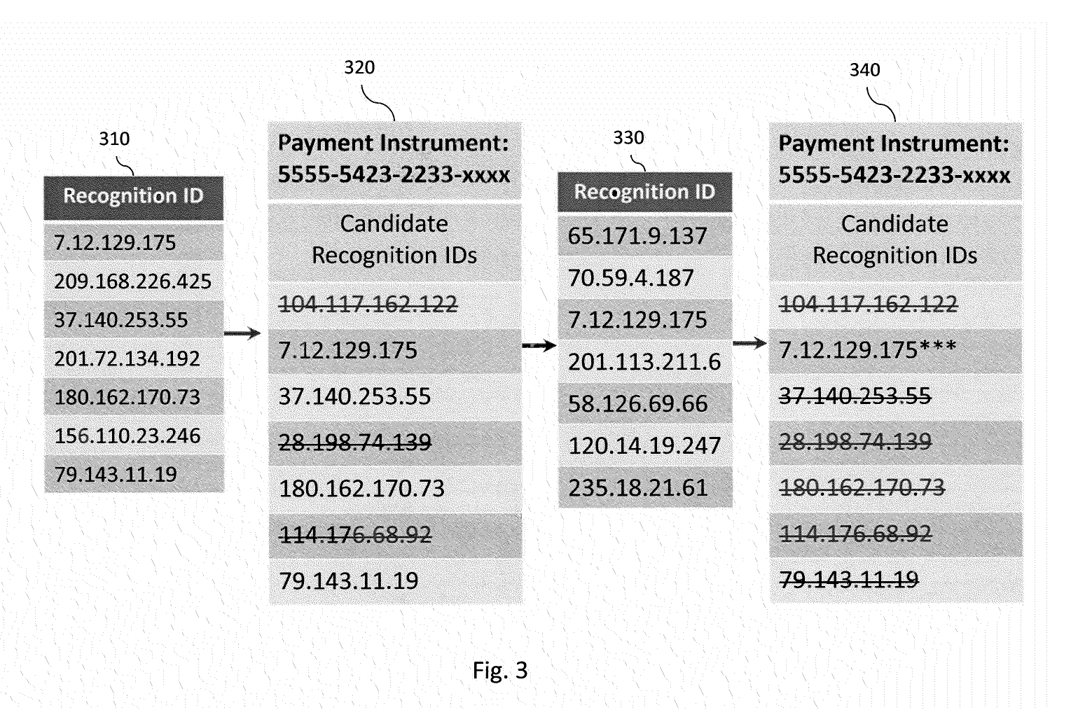

Referring to FIG. 3, there is shown basic steps of an embodiment of the disclosure, specifically showing execution of the present disclosure in the event a payment instrument has previously been associated with a data structure, as above. As one of skill in the art would know, the process taking place in FIG. 3 is displayed in a simplified manner for the sake of explanation, as in the real world millions of recognition IDs might be processed at any one time. At 310, pluralities of recognition IDs are received. In this example, the recognition IDs received are IP addresses of personal computing devices received via logging into a Wi-Fi network at a certain Starbucks®, for example. In most embodiments of this disclosure, millions of recognition IDs would be received, but only seven are shown for simplicity's sake. At 320, is a table associating payment instrument 5555-5423-2233-xxxx with seven recognition IDs. Since this table has already been populated with seven candidate recognition IDs, it indicates that a previous execution of an embodiment of the disclosure has executed. The seven deviceholder identifications within 320 are narrowed down based upon a comparison with recognition IDs found in 310. The computing device performs a matching whereby any recognition IDs not found in 310 are eliminated from 320. Here, since recognition IDs 104.117.162.122, 28.198.74.139, and 114.176.68.92 were not found in the latest collection of recognition IDs 310, they are eliminated as candidate IDs. At 330, another collection of recognition IDs takes place. The computing device then again compares the newly-received recognition IDs with the candidate recognition IDs contained in the table associating the payment instrument 5555-5423-2233-xxxx with candidate recognition IDs. After this process completes, only a single recognition ID, and the computing device associated with the matching database thus “learns” that payment instrument 5555-5423-2233-xxxx is associated with recognition ID 7.12.129.175.

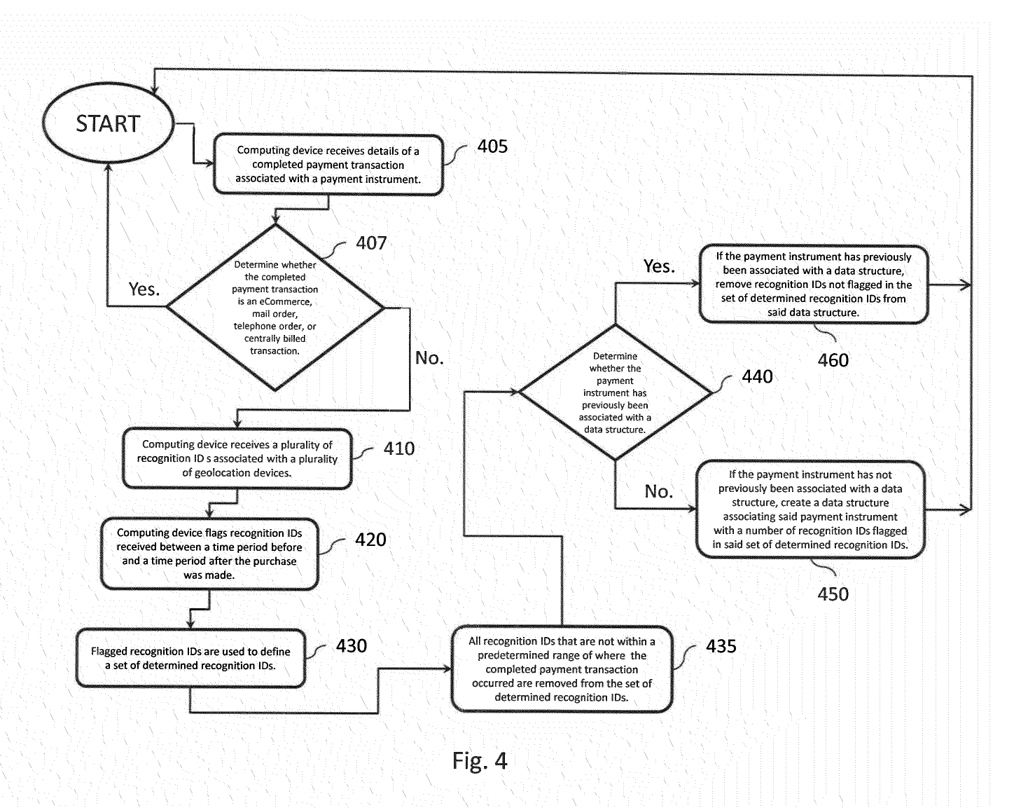

Referring to FIG. 4, shown a flow chart displaying basic steps of a method comprising an embodiment of the disclosure. As previously described, the computing device receives details of a completed payment transaction from a customer making a purchase at a merchant utilizing a payment instrument (step 405). In the present embodiment, in order to reduce the complexity of processing millions of completed payment transactions, the computing device immediately removes all e-commerce, mail order, telephone order, and centrally-billed transactions from consideration, as these will not be associated with a geolocation of a purchase and would otherwise unnecessarily increase program complexity. An initial determination is made of whether the completed payment transaction is an e-commerce, mail order, telephone order, or centrally-billed transaction (step 407). If yes, execution returns to START because there will be no physical geolocation associated with the purchase. If the determination is made that the completed payment transaction is not an e-commerce, mail order, telephone order, or centrally-billed transaction, execution proceeds to step 410, where the computing device, as previously, receives a plurality of recognition IDs associated with a plurality of personal computing devices that each provide a geolocation. The computing device then flags all recognition IDs received within time interval(s) relative to before and/or after the completed payment transaction was processed and a time period after (step 420). The identified flagged recognition IDs are used to define a set of determined recognition IDs (step 430). The computing device further reduces the number of recognition IDs from consideration by removing all recognition IDs that are not within a predetermined range of where the details of the completed payment transaction indicate the completed payment transaction occurred (step 435). This step is performed in some embodiments to reduce the computational complexity of processing millions of recognition IDs.

The predetermined range can be determined in various ways. One is simply by calculation of a radius in meters, kilometers, miles, or any other equivalent means of calculating distance from the location where the completed payment transaction occurred. Another is by calculation of range with the formulae:

$$criterion = \frac{r}{ln ( txn density )} = \frac{r}{ln ( number of transaction ) - ln ( π ) - 2 ln ( r )}$$

In the formula as above, r is calculated based upon predetermined or user-selected values. For example, r could be of the set {3, 5, 10, 15, 20}. The term txn density is calculated based upon the number of completed payment transactions in a given area. This term changes, for example, in an area like northern Canada versus New York City, thus allowing better results to be achieved based upon the location where the completed payment transaction is occurring. The mathematical function in has its normal meaning. Alternative formulae include elimination of the txn term and replacing txn density with deviceholder density.

After step 435 completes, in some embodiments, a determination takes place of whether the payment instrument has previously been associated with a data structure (step 440) linking candidate recognition IDs with a payment instrument. If the payment instrument has previously been associated as such, at step 460, candidate recognition IDs that are not flagged are removed in this execution of the present disclosure, as these cannot be the correct ones. If the payment instrument has not been associated with candidate recognition IDs, at step 450, the payment instrument is associated with the flagged recognition IDs, which have now become candidate recognition IDs. In some embodiments, execution then restarts.

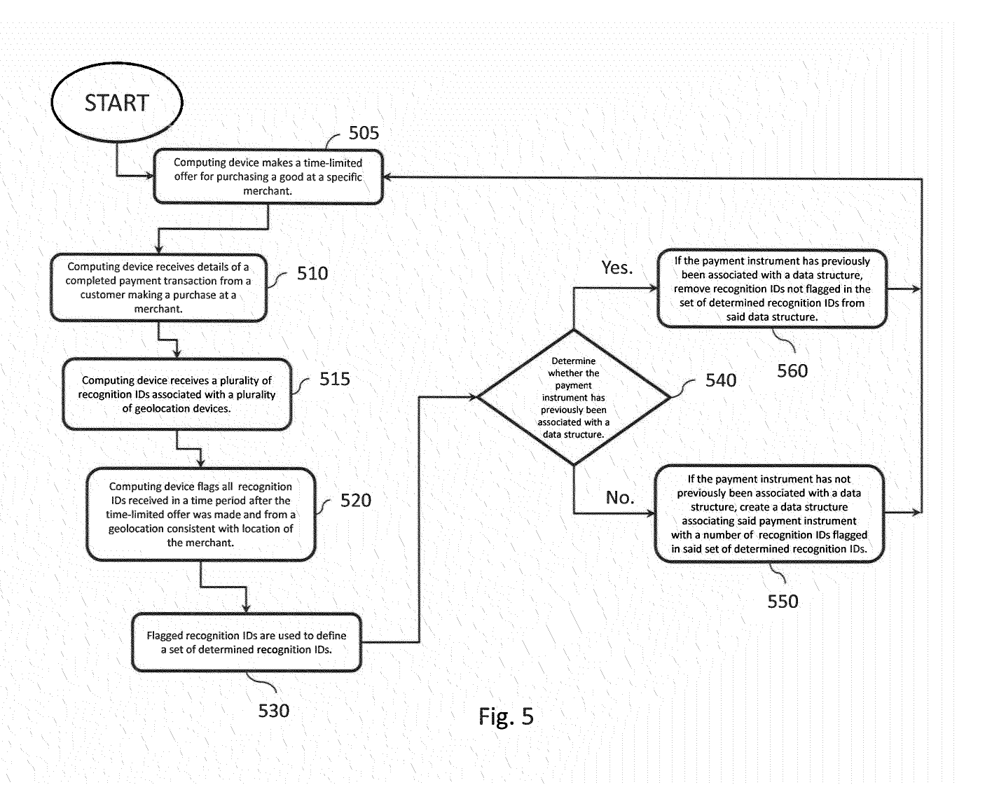

Referring to FIG. 5, shown is a flow chart displaying basic steps of a method comprising an embodiment of the disclosure. In this embodiment, the computing device makes a time-limited offer for purchasing a good at a specific merchant (step 505) (e.g., $3 for two slices of pizza at Mario's! Offer valid for the next hour!). As with previous embodiments, at step 510, the computing device receives details of a completed transaction from a customer making a purchase at a merchant. At step 515, the computing device receives a plurality of recognition IDs associated with a plurality of geolocation devices. In this embodiment, at step 520, the computing device flags all recognition IDs received in a time period after the time-limited offer was made and in a geolocation consistent with the location of the merchant. As with previous embodiments, at step 530, the flagged recognition IDs are used to define a set of flagged recognition IDs. Again, as previously, at step 540, a determination is made whether the payment instrument has previously been associated with a data structure linking candidate recognition IDs with a payment instrument. If no, at step 550, the payment instrument is associated with the flagged recognition IDs, which have now become candidate recognition IDs. If yes, i.e., the payment instrument has previously been associated as such, at step 560 the recognition IDs not flagged are removed in this execution of the present disclosure, as these cannot be the correct ones. At step 560, the recognition IDs not found in the present iteration of the determined recognition IDs can simply be removed from the association, leaving less possible matches of payment instrument to recognition IDs.

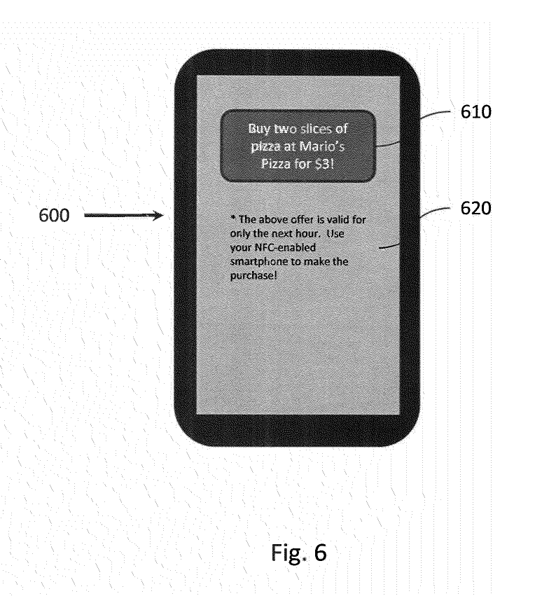

Referring to FIG. 6, displayed is an embodiment of the disclosure executing on a personal computing device 600. Customers are presented with a time-limited offer in real-time to buy a good or service from a specific merchant. The offer is displayed 610. The details of the offer are also displayed 620.

As would be appreciated by one of skill in the art, the present disclosure will comply with all relevant state, federal, and international laws regarding data privacy. The primary intent of the present disclosure is directed to fraud prevention and maintenance of internal statistics.

1. A method of associating a geolocation device configured to transmit a recognition ID with a payment instrument, said method comprising:
receiving details at a computing device associated with a matching database of a first completed payment transaction associated with a payment instrument, said payment instrument associated with a deviceholder identification;
receiving a plurality of recognition IDs associated with a plurality of geolocation devices;
flagging all recognition IDs received within a/time interval/s relative to before and/or after completion of said first completed payment transaction to define a first set of flagged recognition IDs;
receiving details of a second completed payment transaction associated with said payment instrument;
flagging all recognition IDs received within a/time interval/s relative to before and/or after completion of said second completed payment transaction to define a second set of flagged recognition IDs;
comparing said first set of flagged recognition IDs and said second set of flagged recognition IDs in identifying recognition IDs found in both said first set of flagged recognition IDs and said second set of flagged recognition IDs as one or more candidate recognition IDs;
associating said payment instrument with said one or more candidate recognition IDs.

2. The method of claim 1 wherein said time interval relative to before completion of said first completed payment transaction is selectively one of thirty seconds, one minute, five minutes, ten minutes, and twenty minutes.

3. The method of claim 1 wherein said time interval relative to after completion of said first completed payment transaction is selectively one of thirty seconds, one minute, five minutes, ten minutes, and twenty minutes.

4. The method of claim 1 wherein said time intervals relative to before and after completion of said first completed payment transaction sum to selectively one minute, two minutes, ten minutes, twenty minutes, and forty minutes.

5. The method of claim 1 wherein said time intervals relative to before and after completion of said first completed payment transaction are symmetric.

6. The method according to claim 1 wherein associating said payment instrument with said one or more candidate recognition IDs occurs in a data structure.

7. The method of claim 6 wherein said data structure is stored in said matching database.

8. The method according to claim 1 wherein associating said payment instrument with said one or more candidate recognition IDs occurs by selectively modifying said first set of flagged recognition IDs, modifying said second set of flagged recognition IDs, and creating a new set of candidate recognition IDs.

9. The method of claim 1 wherein at least some of said received plurality of recognition IDs are received at said computing device selectively one of before, during, and after a time of receiving said details of first completed instrument transaction.

10. The method of claim 1 further comprising after flagging all recognition IDs received to define a first set of flagged recognition IDs, removing from said first set of flagged recognitions IDs all recognition IDs not within a predetermined range of where said received details of said first completed payment transaction indicate said transaction has occurred.

11. The method of claim 10 wherein said predetermined range is selectively one of 3 miles, 5 miles, 10 miles, 15 miles, and 20 miles.

12. The method of claim 10 wherein said predetermined range is user-definable.

13. The method of claim 10 wherein said predetermined range is described by the formula:
$$\frac{r}{ln ( number of transactions ) - ln ( π ) - 2 ln ( r )}$$

14. The method of claim 13 wherein r equals selectively one of 3, 5, 10, 15, and 20.

15. The method of claim 1 wherein receiving details of a first completed payment transaction further comprises:
determining whether said received details of first completed payment transaction indicate said first completed payment transaction is an e-commerce, mail order, telephone order, or centrally-billed transaction and, if so, ignoring said received details of first completed payment transaction.

16. A system for associating a geolocation device configured to transmit a recognition ID with a payment instrument, said system comprising:
a computing device associated with a matching database receives details of a first completed payment transaction associated with a payment instrument, said payment instrument associated with a deviceholder identification;
said computing device receives a plurality of recognition IDs associated with a plurality of geolocation devices;
said computing device flags all recognition IDs received within a/time interval/s relative to before and/or after completion of said first completed payment transaction to define a first set of flagged recognition IDs;
said computing device receives details of a second completed payment transaction associated with said payment instrument;
said computing device flags all recognition IDs received within a/time interval/s relative to before and/or after completion of said second completed payment transaction to define a second set of flagged recognition IDs;
said computing device compares said first set of flagged recognition IDs and said second set of flagged recognition IDs in identifying recognition IDs identified in both said first set of flagged recognition IDs and said second set of flagged recognition IDs as one or more candidate recognition IDs;
said computing device associates said payment instrument with said candidate recognition IDs.

17. The system of claim 16 wherein said time interval relative to before completion of said first completed payment transaction is selectively one of thirty seconds, one minute, five minutes, ten minutes, and twenty minutes.

18. The system of claim 16 wherein said time interval relative to after completion of said first completed payment transaction is selectively one of thirty seconds, one minute, five minutes, ten minutes, and twenty minutes.

19. The system of claim 16 wherein said time intervals relative to before and after completion of said first completed payment transaction sum to selectively one minute, two minutes, ten minutes, twenty minutes, and forty minutes.

20. The system of claim 16 wherein said time intervals relative to before and after completion of said first completed payment transaction are symmetric.

21. The system of claim 16 wherein said computing device associates said payment instrument with said one or more candidate recognition IDs in a data structure.

22. The system of claim 21 wherein said data structure is stored in said matching database.

23. The system of claim 16 wherein said computing device associates said payment instrument with said one or more candidate recognition IDs by selectively modifying said first set of flagged recognition IDs, modifying said second set of flagged recognition IDs, and creating a new set of candidate recognition IDs.

24. The system of claim 16 wherein at least some of said received plurality of recognition IDs are received at said computing device selectively one of before, during, and after a time of receiving said details of first completed instrument transaction.

25. The system of claim 16 wherein said computing device after flagging all recognition IDs received to define a first set of flagged recognition IDs, removes from said first set of flagged recognitions IDs all recognition IDs not within a predetermined range of where said received details of said first completed payment transaction indicate said transaction has occurred.

26. The system of claim 25 wherein said predetermined range is selectively one of 3 miles, 5 miles, 10 miles, 15 miles, and 20 miles.

27. The system of claim 25 wherein said predetermined range is user-definable.

28. The system of claim 25 wherein said predetermined range is described by the formula:
$$\frac{r}{ln ( number of transactions ) - ln ( π ) - 2 ln ( r )}$$

29. The system of claim 28 wherein r equals selectively one of 3, 5, 10, 15, and 20.

30. The system of claim 16 wherein receiving details of a first completed payment transaction further comprises:
determining whether said received details of first completed payment transaction indicate said first completed payment transaction is an e-commerce, mail order, telephone order, or centrally billed transaction, and if so, ignoring said received details of first completed payment transaction.

31. A method of associating a geolocation device configured to transmit a recognition ID with a payment instrument, said method comprising:
transmitting a time-limited offer to a personal computing device associated with a customer for purchasing a good or service from a specific merchant at a certain location;
receiving details at a computing device associated with a matching database of a first completed payment transaction associated with a payment instrument, said payment instrument associated with a deviceholder identification;
receiving a plurality of recognition IDs associated with a plurality of geolocation devices;
flagging all recognition IDs received within a time interval during which said time-limited offer is valid and from a geolocation consistent with the certain location of the specific merchant to define a set of flagged recognition IDs;
associating said payment instrument with said candidate recognition IDs.

32. The method of claim 31 wherein associating said payment instrument with said candidate recognition ID occurs in a data structure.

33. The method of claim 32 wherein said data structure is stored in said matching database.

34. The method of claim 31 wherein said time-limited offer is valid for selectively one of five minutes, ten minutes, fifteen minutes, thirty minutes, and one hour.
